(19) United States
(12) Patent Application Publication
(10) Pub. No.: US 2023/0029950 A1
(43) Pub. Date: Feb. 2, 2023

(54) Fishing Accessory Securement System and Related Methods

(71) Applicant: William P. Bishop, Midway, UT (US)

(72) Inventor: William P. Bishop, Midway, UT (US)

(21) Appl. No.: 17/703,756

(22) Filed: Mar. 24, 2022

Related U.S. Application Data
(60) Provisional application No. 63/203,717, filed on Jul. 29, 2021.

(51) Int. Cl. A01K 77/00

(52) U.S. Cl. CPC A01K 77/00

(57) ABSTRACT

A landing net securement system includes a landing net with a net body having a net end and a handle end. A net attachment fixture is carried by the net body in a location distal from both the net end and the handle end of the net body. A clip assembly is attachable to clothing worn by a fisher, the clip assembly carrying a body attachment fixture operable to mate with the net attachment fixture to enable securement of the landing net to the clothing of the fisher.

### PRIORITY CLAIM

Priority is claimed of and to U.S. Provisional Patent Application Ser. No. 63/203,717, filed Jul. 29, 2021, which is hereby incorporated herein by reference in its entirety.

### BACKGROUND OF THE INVENTION

### Field of the Technology

The present technology relates generally to hand-held landing nets used in fishing. More particularly, the present technology relates to adapting such landing nets so they can be easily carried upon the body of a person fishing (e.g., a “fisher”).

### Related Art

Hand-held landing nets are commonly used in fishing to withdraw a hooked fish from water. Such nets aid a fisher in grasping the landed fish, and also help protect the landed fish during the process. While landing nets are very often carried by those engaged in fly fishing and other fishing endeavors, they are generally only used when landing a fish. As such, most of the time spent fishing does not require the use of the landing net. However, due to the nature of fly fishing in particular, it is desirable to maintain the net near at hand to allow quick use when required.

Thus, while most fishers desire easy access to such nets, they become frustrated by the cumbersome nature of carrying the nets when not in use. Some conventional systems have been developed that allow a user to securely attaching the nets to the fisher's body or clothing. However, such systems have generally proved disadvantageous in that they either do not maintain the net in an easily accessible location, or they require significant effort on the fisher's part to disentangle the net from his or her clothing or body.

### SUMMARY OF THE INVENTION

In accordance with one aspect of the invention, a landing net securement system is provided, including a landing net having a net body with a net end and a handle end. A net attachment fixture can be carried by the net body in a location distal from both the net end and the handle end of the net body. A clip assembly can be attachable to clothing worn by a fisher. The clip assembly can carry a body attachment fixture that can be operable to mate with the net attachment fixture to enable securement of the landing net to the clothing of the fisher.

In accordance with another aspect of the technology, a kit is provided for providing a securement system to a landing net having a net body with a net end and a handle end. The kit can include a net attachment fixture and a clip assembly. The clip assembly can be attachable to clothing worn by a fisher and can carry a body attachment fixture. Instructions can be provided for attaching the net attachment fixture to the net body in a location distal from both the net end and the handle end of the net body, the net attachment fixture thereby becoming operable to mate with the body attachment fixture to enable securement of the landing net to the clothing of the fisher.

In accordance with another aspect of the technology, a method is provided of providing a securement system to a landing net having a net body with a net end and a handle end. The method can include attaching a net attachment fixture to the net body in a location distal from both the net end and the handle end of the net body. The method can include associating the landing net with a clip assembly, the clip assembly being attachable to clothing worn by a fisher, the clip assembly carrying a body attachment fixture operable to mate with the net attachment fixture to thereby enable securement of the landing net to the clothing of the fisher.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a plan view of an exemplary landing net having a securement system associated therewith in accordance with an embodiment of the present technology;

FIG. 2 is a front view of the securement system of FIG. 1, shown with the landing net secured to a belt of a fisher;

FIG. 3 is a perspective view of a kit for applying a securement system to a landing net, with a partial view of a landing net for use therewith; and

FIG. 4 is a side view of an exemplary clip or clamp for use with the present technology.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Definitions

As used herein, the singular forms “a” and “the” can include plural referents unless the context clearly dictates otherwise. Thus, for example, reference to “an attachment fixture” can include one or more of such fixtures, if the context dictates.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item so long as there is no measurable effect as a result thereof.

As used herein, the term “about” is used to provide flexibility to a numerical range endpoint by providing that a given value may be “a little above” or “a little below” the endpoint.

Relative directional terms can sometimes be used herein to describe and claim various components of the present invention. Such terms include, without limitation, “upward,” “downward,” “horizontal,” “vertical,” etc. These terms are generally not intended to be limiting, but are used to most clearly describe and claim the various features of the invention. Where such terms must carry some limitation, they are intended to be limited to usage commonly known and understood by those of ordinary skill in the art in the context of this disclosure.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Invention The present technology relates to generally to systems by which a fishing landing net can carried upon the body of a fisher to provide a secure manner of carrying the landing net while also providing easy access to the landing net when desired. The present technology both maintains the net in an easily accessible, yet secure, position on the fisher's body, and allows easy disengagement from the fisher's body.

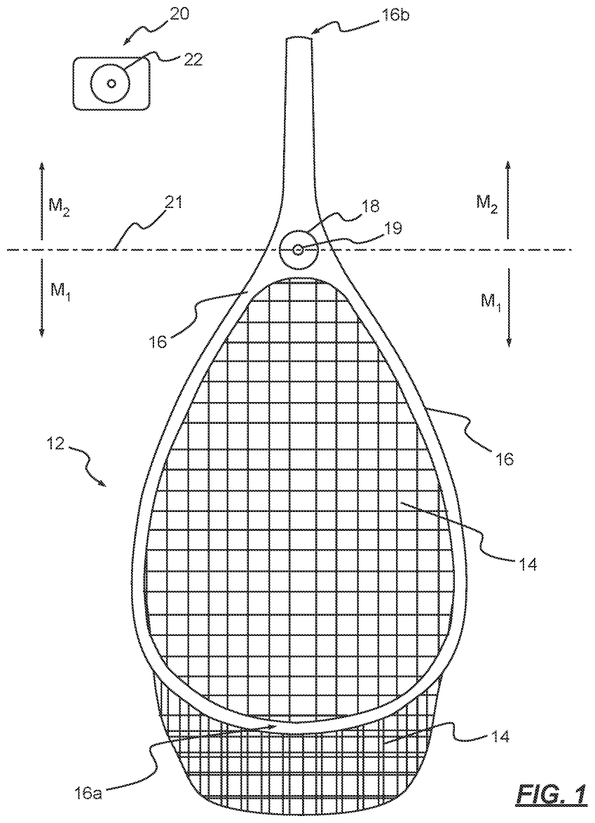

As shown generally in FIG. 1, in one aspect of the technology, a landing net securement system 10 is provided that can include a landing net 12. The landing net can be any of a variety of configurations commercially available. As is known in the art, the net can include a net portion 14 that can include a series of filaments or the like formed of natural fiber thread, nylon, etc. The net can include a net body 16 having a net end 16a and a handle end 16b. The net body can be formed from a variety of known materials, including wood, aluminum, polymers, etc.

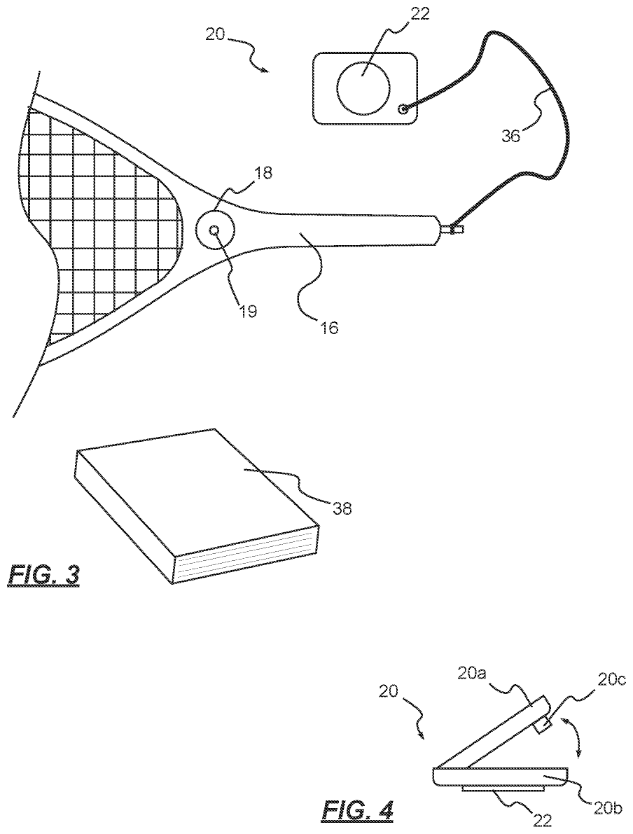

A net attachment fixture 18 can be carried by the net body 16 in a location distal from both the net end 16a and the handle end 16b of the net body. While this attachment position can vary, in the examples shown the attachment fixture 18 is carried by the net body near the yoke, immediately prior to the location where the net body expands into a hoop to which the net portion 14 is generally attached. The system can also include a body assembly, shown by example as a clip assembly 20 (see also FIG. 4), attachable to clothing worn by a fisher. The body or clip assembly can carry a body attachment fixture 22 that can be operable to mate with the net attachment fixture 18 to enable securement of the landing net to the clothing of the fisher. While the body assembly can include a clipping structure, it is to be understood that the body assembly can be attached to or associated with clothing in a variety of manners: for example, it can be sewn to clothing, attached with hook-and-loop fasteners, etc.

As that term is used herein, “clothing” can refer to a variety of garments or structures typically worn or carried on a user's body. Examples include, without limitation, belts, straps, vests, pants, shirts, coats, carrying packs, suspenders, and the like.

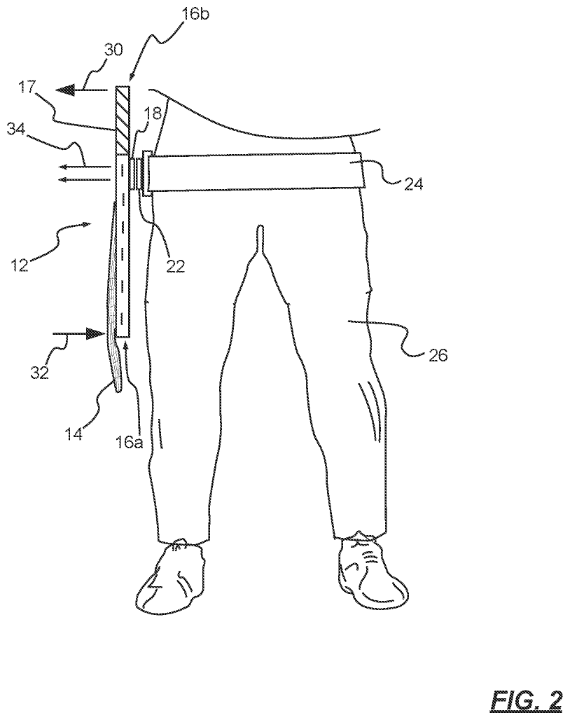

FIG. 2 illustrates the technology in use retaining or securing the net 12 to a belt or strap 24 carried upon the person (in this case, about the hips) of a fisher 26. As can be seen, attachment fixture 18 carried by the net is attached to attachment fixture 22 carried by the clip 20. The clip 20 is in turn secured to the belt or strap 24. In this manner, the fisher can perform all of the usual tasks associated with fishing, without the net interfering in any significant manner with normal activity. However, when needed, the net is close at hand and can be easily and quickly deployed by the fisher for use. When finished with the net, the fisher can very easily reengage the attachment fixtures 18, 22 and again secure the net in position on his or her body.

The attachment fixtures 18, 22 can take a variety of forms, so long as the two can engage one another with sufficient force to function in the manner described herein. In one embodiment, the attachment fixtures comprise or include a material that creates a magnetic force between the two fixtures. For example, one or both of the fixtures can comprise or include a ferromagnetic material, such as iron, cobalt, nickel, etc., and one or both of the fixtures can be magnetized. In some embodiments, both of the fixtures comprise or include a magnet. As will be appreciated from the figures, once the fixtures are placed in near vicinity to one another, they form an attachment that maintains the net in the desired position. In other embodiments, other attachment fixtures can be utilized, such as hook-and-loop fasteners, mechanical “holster” arrangements, friction-fit arrangements, etc.

The present technology advantageously provides manners by which the handle end 16b of the net 14 can be positioned upwardly relative to a fisher's hip, to enable the fisher to very easily grasp the handle. The position shown in FIG. 2 is advantageous not only for this feature, but this position allows the user to utilize leverage to disengage the attachment fixtures 18, 22 from one another. Once the user grasps the handle portion of the net, he or she can apply force outwardly at shown at 30. This force translates to an inward force 32 applied to the user's leg. This leverage amplifies the force applied by the user to the handle through the attachment fixtures. In this manner, the force applied by the user to separate the attachment fixtures is greater than he or she could normally apply by hand.

Accordingly, in one aspect of the technology, the handle end 16b of the net 14 is remains untethered and free to move when the net is in the storage position (that shown in FIG. 2), to enable movement of the handle end away from the user's 26 body to enable the user to apply the leveraged force. In another aspect, both the handle end 16b and the net end 16a are untethered and free to move when the net is in the storage position. The user can grasp the handle end (e.g., grip portion 17) from above, without any attachment structure interfering with the grasp. In one aspect, the attachment fixtures are disengageable by applying a force outward from the user's body or waist, so that the fisher need not lift the net upwardly or downwardly when disengaging it from his or her body.

This results in the ability to utilize much stronger attachment fixtures than might otherwise be feasible. It has been found, for example, that when a relatively weak magnet combination is used for the attachment fixtures, the net may become inadvertently dislodged during activities normally encountered during fishing. For example, the net may become dislodged as the fisher moves past brush or foliage. On the other hand, if a conventional attachment approach is utilized with a very strong magnet combination, the net may not easily separate from the user, but some users may have difficulty separating the magnets when it is desired to use the net.

Even large ferrite magnets, which are not as strong as other permanent magnets, can be difficult for some users to separate by hand. Magnets such as neodymium magnets can be very difficult for users to separate by hand. The present arrangement, however, can provide sufficient leverage to allow even small users to separate the attachment fixtures 18, 22, by applying a leveraging force 30 to the handle end 16b of the net 12, which then applies a force 32 against the user's leg, resulting in a sufficient force 34 to separate the attachment fixtures. In this manner, a strong enough attachment force can be applied to maintain the net in position on the user, while still allowing users to remove the net when desired. As illustrated in FIG. 1, in one embodiment of the technology, the net attachment fixture 18 can be carried by the net body 16 in a location such that a mass “M₁” of the net body between the net attachment fixture 18 and the net end 16b is greater than a mass “M₂” of the net body between the net attachment fixture 18 and the handle end 16a. In the example shown, line 21 represents the location of attachment of the net, with one mass existing below and one mass existing above this delineation. This embodiment can aid in maintaining the handle end of the net in a desired location to enable a user to easily grasp the handle. As the net end will tend to rotate downwardly relative to the handle end about the attachment point, this feature allows the system to substantially self-correct for orientation without the user having to invest significant attention when returning the net to the secured position.

Further to this, the manner in which the net attachment fixture 18 and the body attachment fixture 22 can be varied to provide relative rotatability at the connection point. For example, one or both the net attachment fixture or body attachment fixture can be rotatably attached to its respective component. This can be accomplished in a number of manners. In one embodiment, for example, the net attachment fixture can comprise or include a hole formed through a center thereof, and a fastener (19 in FIG. 1, e.g., a bolt and nut, screw, etc.) can be installed through the hole and into the body 16 of the net 14. In this manner, the net attachment fixture 18 can rotate relative to the net body.

This same approach can be utilized with the body attachment fixture on the clip 20, in addition to or instead of the net body attachment rotation. In other embodiments, the attachment fixtures can be rotatably fixed relative to their respective component, but the magnets (or ferromagnetic material) utilized can self-align as they attach to one another. This can be accomplished, for example, using a magnetization technique that provides directionality to the magnetic attraction between the attachment fixtures.

Using one or both of these approaches can result in the net being rotatable relative to the user when the net is in the storage position shown in FIG. 2. In this manner, the user can position the net in the easiest position for him or her to manipulate when storing or retrieving the net. The net can be rotatable when the attachment fixtures 18, 22 are coupled one to another.

As illustrated in FIG. 3, the system can also include a tether 36 that can be coupled between the landing net 14 and the clip assembly 20. The tether can be formed from an elastic material, to enable a user to extend the net from the clip assembly when desired. The elasticity in the tether, however, aids the user in returning the net to the clip assembly after use, and also aids in retrieving the net should it be inadvertently dropped. FIG. 2 also illustrates components of a kit provided by the present technology.

The kit can include a net attachment fixture 18 and a clip assembly 20, attachable to clothing worn by a fisher. The clip assembly can carry a body attachment fixture 22. Instructions 38 can be provided for attaching the net attachment fixture to the net body in a location distal from both the net end and the handle end of the net body. The net attachment fixture thereby becomes operable to mate with the body attachment fixture to enable securement of the landing net to the clothing of the fisher. In accordance with one aspect of the technology, the instructions can instruct attachment of the net attachment fixture on a location of the body of the net such that a mass of the net body between the net attachment fixture and the net end is greater than a mass of the net body between the net attachment fixture and the handle end.

FIG. 4 illustrates schematically operation of one exemplary clip assembly 20. In this example, the clip assembly can include a pair of pivotally attached clamshells 20a, 20b, and a latch 20c. In use, a fisher can open the clamshells and install the clip about a belt, pants, suspenders, shirt, etc., of the fisher. The clip assembly can carry the body attachment fixture 22. It is noted that, while the body attachment fixture 22 is illustrated as attached to or carried by the clip assembly, in some embodiments the body attachment fixture can be attached directly to an article of clothing of the fisher, or to some other accessory the fisher may carry. In particular, a belt can be relatively easily modified to carry the body attachment fixture, in which case the clip assembly may not be necessary.

In accordance with another aspect of the technology, a method can be provided of providing a securement system to a landing net having a net body with a net end and a handle end. The method can include attaching a net attachment fixture to the net body in a location distal from both the net end and the handle end of the net body. The landing net can be associated with a clip assembly, the clip assembly being attachable to clothing worn by a fisher, the clip assembly carrying a body attachment fixture operable to mate with the net attachment fixture to thereby enable securement of the landing net to the clothing of the fisher.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the examples.

I claim:

1. A landing net securement system, comprising:
a landing net, including:
a net body having a net end and a handle end;
a net attachment fixture carried by the net body in a location distal from both the net end and the handle end of the net body; and
a body assembly, attachable to clothing worn by a fisher, the body assembly carrying a body attachment fixture operable to mate with the net attachment fixture to enable securement of the landing net to the clothing of the fisher.

2. The system of claim 1, wherein the net attachment fixture is carried by the net body in a location such that a mass of the net body between the net attachment fixture and the net end is greater than a mass of the net body between the net attachment fixture and the handle end.

3. The system of claim 1, wherein the net attachment fixture and the body attachment fixture each include a ferromagnetic material.

4. The system of claim 3, wherein at least one of the net attachment fixture and the body attachment fixture include a magnet.

5. The system of claim 3, wherein both the net attachment fixture and the body attachment fixture include magnets.

6. The system of claim 1, wherein one or both of the net attachment fixture and the body attachment fixture are rotatably carried respectably by the net body or the body assembly.

7. The system of claim 1, further comprising a tether, coupled between the landing net and the body assembly.

8. A kit for providing a securement system to a landing net having a net body with a net end and a handle end, the kit comprising:
a net attachment fixture;
a body assembly, attachable to clothing worn by a fisher, the body assembly carrying a body attachment fixture; and
instructions for attaching the net attachment fixture to the net body in a location distal from both the net end and the handle end of the net body, the net attachment fixture thereby becoming operable to mate with the body attachment fixture to enable securement of the landing net to the clothing of the fisher.

9. The kit of claim 8, wherein the instructions instruct attachment of the net attachment fixture on a location of the body of the net such that a mass of the net body between the net attachment fixture and the net end is greater than a mass of the net body between the net attachment fixture and the handle end.

10. The kit of claim 8, wherein the net attachment fixture and the body attachment fixture each include a ferromagnetic material.

11. The kit of claim 10, wherein at least one of the net attachment fixture and the body attachment fixture include a magnet.

12. The kit of claim 10, wherein both the net attachment fixture and the body attachment fixture include magnets.

13. The kit of claim 8, wherein one or both of the net attachment fixture and the body attachment fixture are rotatably carried respectably by the net body or the body assembly.

14. The kit of claim 8, further comprising a tether, coupleable between the landing net and the body assembly.

15. A method of providing a securement system to a landing net having a net body with a net end and a handle end, the method comprising:
attaching a net attachment fixture to the net body in a location distal from both the net end and the handle end of the net body;
associating the landing net with a body assembly, the body assembly being attachable to clothing worn by a fisher, the body assembly carrying a body attachment fixture operable to mate with the net attachment fixture to thereby enable securement of the landing net to the clothing of the fisher.

16. The method of claim 15, wherein attaching the net attachment fixture to the net body comprises attaching the net attachment fixture in a location that results in a mass of the net body between the net attachment fixture and the net end being greater than a mass of the net body between the net attachment fixture and the handle end.

17. The method of claim 15, wherein the net attachment fixture and the body attachment fixture each include a ferromagnetic material.

18. The method of claim 17, wherein at least one of the net attachment fixture and the body attachment fixture include a magnet.

19. The method of claim 15, wherein one or both of the net attachment fixture and the body attachment fixture are rotatably carried respectably by the net body or the body assembly.

20. The method of claim 15, further comprising a tether, coupled between the landing net and the body assembly.
